(19) United States
(12) Patent Application Publication
(10) Pub. No.: US 2025/0153780 A1
(43) Pub. Date: May 15, 2025

(54) REINFORCING A STRUCTURE HAVING AN OPEN PROFILE USING A METAL PLATE

(71) Applicant: Atieva, Inc., Newark, CA (US)

(72) Inventors: Lucas Jungmann, Newark, CA (US); Adam Johnson Fecteau, San Jose, CA (US)

(21) Appl. No.: 18/510,214

(22) Filed: Nov. 15, 2023

(51) Int. Cl. B62D 25/14; B60R 13/02; B62D 1/16; B62D 27/02

(52) U.S. Cl. CPC B62D 25/145; B60R 13/0256; B62D 1/16; B62D 27/023

(57) ABSTRACT

A vehicle comprises: a vehicle body including a passenger compartment; and a cross-vehicle beam extending in a transverse direction inside the passenger compartment, the cross-vehicle beam having an open profile, wherein an opening of the open profile faces forward in the vehicle, the cross-vehicle beam including a first metal plate, wherein a shape of a part of a periphery of the first metal plate corresponds to a shape of the open profile, and wherein the first metal plate is mounted in the open profile substantially perpendicular to a longitudinal axis of the cross-vehicle beam.

### TECHNICAL FIELD

This document relates to reinforcing a structure having an open profile using a metal plate.

### BACKGROUND

In vehicle bodies, metal structures are used in a variety of places to create the strength and stiffness needed for the overall design. Designing a beam or other metal structure with a closed cross section can provide advantageous noise vibration harshness (NVH) performance but adds mass to the vehicle. A cross-vehicle beam is a structural component of a vehicle that is also responsible for modal, crash and quality performance.

### SUMMARY

In a first aspect, a vehicle comprises: a vehicle body including a passenger compartment; and a cross-vehicle beam extending in a transverse direction inside the passenger compartment, the cross-vehicle beam having an open profile, wherein an opening of the open profile faces forward in the vehicle, the cross-vehicle beam including a first metal plate, wherein a shape of a part of a periphery of the first metal plate corresponds to a shape of the open profile, and wherein the first metal plate is mounted in the open profile substantially perpendicular to a longitudinal axis of the cross-vehicle beam.

Implementations can include any or all of the following features. The vehicle further comprises an overmolding of a plastic material on the cross-vehicle beam, wherein the first metal plate is attached to the open profile by the overmolding. The first metal plate includes a tab at the part of the periphery, wherein the open profile has a slot, and wherein the tab extends into the slot when the first metal plate is mounted in the open profile. A first hole extends through the cross-vehicle beam, and wherein the plastic material extends through the first hole as a result of the overmolding. A second hole extends through the first metal plate, and wherein the plastic material extends through the second hole as a result of the overmolding. The first metal plate is attached to the open profile by at least one weld joint. The first metal plate includes a tab at the part of the periphery, wherein the open profile has a slot, and wherein the tab extends into the slot when the first metal plate is mounted in the open profile. The cross-vehicle beam further includes a second metal plate, wherein a shape of a part of a periphery of the second metal plate corresponds to the shape of the open profile, and wherein the second metal plate is mounted in the open profile substantially perpendicular to the longitudinal axis of the cross-vehicle beam. The vehicle further comprises a steering column mounted to the cross-vehicle beam. The first metal plate is positioned adjacent to the steering column along the cross-vehicle beam.

In a second aspect, a vehicle structure comprises: a metal beam having an open profile, the metal beam configured to be part of a vehicle body; and a first metal plate, wherein a shape of a part of a periphery of the first metal plate corresponds to a shape of the open profile, and wherein the first metal plate is mounted in the open profile substantially perpendicular to a longitudinal axis of the metal beam.

Implementations can include any or all of the following features. The vehicle structure further comprises an overmolding of a plastic material on the metal beam, wherein the first metal plate is attached to the open profile by the overmolding. The first metal plate includes a tab at the part of the periphery, wherein the open profile has a slot, and wherein the tab extends into the slot when the first metal plate is mounted in the open profile. A first hole extends through the metal beam, and wherein the plastic material extends through the first hole as a result of the overmolding. A second hole extends through the first metal plate, and wherein the plastic material extends through the second hole as a result of the overmolding. The first metal plate is attached to the open profile by at least one weld joint. The first metal plate includes a tab at the part of the periphery, wherein the open profile has a slot, and wherein the tab extends into the slot when the first metal plate is mounted in the open profile. The vehicle structure further comprises a second metal plate, wherein a shape of a part of a periphery of the second metal plate corresponds to the shape of the open profile, and wherein the second metal plate is mounted in the open profile substantially perpendicular to the longitudinal axis of the metal beam. The vehicle structure is a cross-vehicle beam.

### BRIEF DESCRIPTION OF DRAWINGS

FIG. 1 shows an example of a cross-vehicle beam.

FIG. 2 shows an example of the cross-vehicle beam of FIG. 1 without one of the plates.

FIG. 3 shows an example of the cross-vehicle beam of FIG. 1.

FIG. 4 shows an example cross section of the metal plate of FIG. 3.

FIG. 5 shows an example of the cross-vehicle beam of FIG. 1 with a steering column.

FIG. 6 shows an example of a vehicle.

Like reference symbols in the various drawings indicate like elements.

### DETAILED DESCRIPTION

This document describes examples of systems and techniques for using a metal plate to reinforce a structure having an open profile. The present subject matter can provide reinforcement for open structural cross sections. The structure being reinforced can be designed for a vehicle body, such as a cross-vehicle beam supporting the instrument panel. In some implementations, a metal structure having an open profile can be provided with one or more vertically oriented reinforcements. For example, this can resist opening (sometimes referred to as “breathing”) of the open-profiled structural section during use (e.g., while a vehicle is moving). Preventing opening or breathing of the section can improve NVH modal performance of the cross-vehicle beam. For example, the NVH modal performance for a steering column can be improved. A significant improvement in vehicle performance can therefore be achieved without incurring the mass increase associated with making the structure a closed profile instead.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons.

Examples described herein refer to a metal beam overmolded with plastic. As used herein, a metal beam overmolded with plastic means a metal beam that is at least partially overmolded with plastic. That is, a metal beam overmolded with plastic can have one or more areas on its surface where the plastic is not present.

Examples described herein refer to a cross-vehicle beam. As used herein, a cross-vehicle beam is a structural component installed in any type of vehicle so as to span substantially from one side of the vehicle to an opposite side of the vehicle. For example, a cross-car beam can extend between the left and right A-pillars of the vehicle.

Examples herein refer to a front, rear, top, or a bottom. These and similar expressions identify things or aspects in a relative way based on an express or arbitrary notion of perspective. That is, these terms are illustrative only, used for purposes of explanation, and do not necessarily indicate the only possible position, direction, and so on.

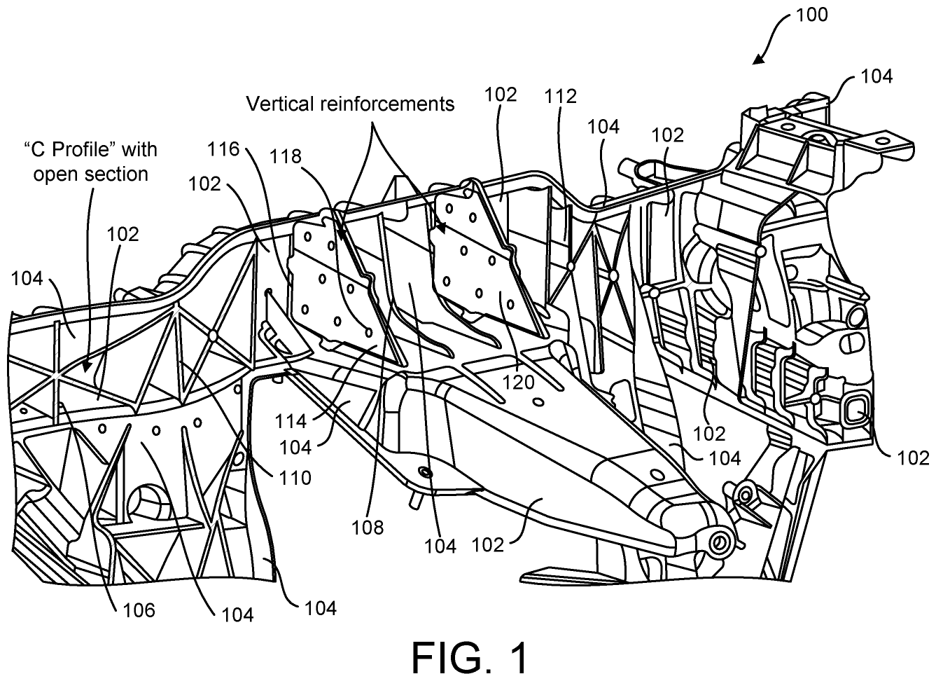

FIG. 1 shows an example of a cross-vehicle beam 100. The cross-vehicle beam 100 can be used with one or more other examples described elsewhere herein. The cross-vehicle beam 100 is here partially shown for simplicity. The cross-vehicle beam 100 can be a structural member extending transversely in a vehicle body. The cross-vehicle beam 100 can be designed to support, and be positioned inside or underneath, an instrument panel in a vehicle. Multiple vehicle components in the passenger compartment, including but not limited to a steering column and a display device, may be directly or indirectly attached to the cross-vehicle beam 100. In some implementations, each end of the cross-vehicle beam 100 can be configured for attachment to a respective A-pillar in the vehicle. The cross-vehicle beam 100 can be made of any suitable material. The cross-vehicle beam 100 can include a metal profile 102 and plastic material 104. The metal profile 102 defines a longitudinal axis along its length between its two ends. The plastic material 104 can be overmolded onto the metal profile 102. In some implementations, injection molding can be performed. For example, a hole 106 extends through the metal profile 102, and the plastic material 104 extends through the hole 106 as a result of the overmolding.

The metal profile 102 of the cross-vehicle beam 100 has an open profile. In this illustration, the opening of the open profile is facing the viewer. For example, the plastic material 104 defines ribs 108, 110 and 112, each of which extends into the opening of the open profile and is substantially perpendicular to the longitudinal axis of the cross-vehicle beam 100. The metal profile 102 can have the open profile along an entirety of the longitudinal axis. For example, the open profile can face forward in the vehicle. In some implementations, the open profile can be a C-profile. The metal profile 102 can be stamped to produce its designed form. Using an open profile can make an overmolding process less complicated because the metal profile 102 does not have any internal hollow space subject to deformation when the plastic material 104 is applied.

The cross-vehicle beam 100 has at least one reinforcement for the open profile of the metal profile 102. A metal plate 114 is mounted to the metal profile 102 in the opening of the open profile and is oriented substantially perpendicular to the longitudinal axis of the cross-vehicle beam 100. The metal plate 114 can be a substantially planar member or can have at least one deviation from a planar geometry. The metal plate 114 has a periphery 116 (e.g., an edge) that can be shaped to ensure that the metal plate 114 fits well in the open profile of the metal profile 102. The shape of a part of the periphery 116 can correspond to the shape of the open profile of the metal profile 102. For example, the part of the periphery 116 that is inside the open profile of the metal profile 102 when the metal plate 114 has been installed can substantially abut the surface of the metal profile 102 in the open profile.

The metal plate 114 is attached to the metal profile 102 in any of multiple ways. In some implementations, overmolding is performed after fitting the metal plate 114 into the open profile of the metal profile 102. For example, a hole 118 extends through the metal plate 114, and the plastic material 104 extends through the hole 118 as a result of the overmolding. The cross-vehicle beam 100 can have one or more reinforcements such as the metal plate 114. Here, a metal plate 120 is also mounted to the metal profile 102 in the opening of the open profile and is oriented substantially perpendicular to the longitudinal axis of the cross-vehicle beam 100. The metal plates 114 and 120 can be substantially parallel to each other. The metal plates 114 and 120 can have substantially the same shape as each other or can have different shapes depending on the shape of the open profile of the metal profile 102 and the design requirements for the vehicle.

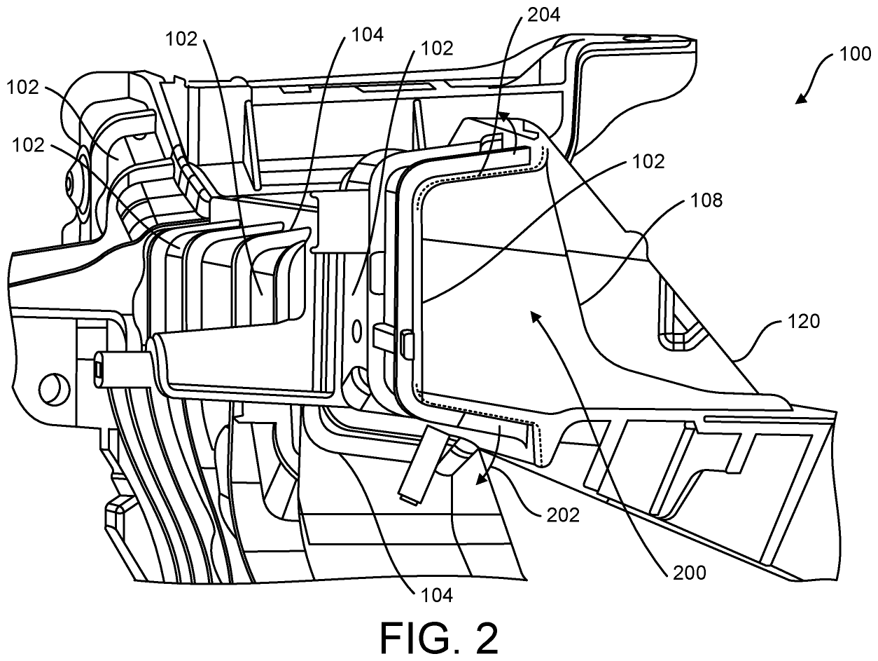

FIG. 2 shows an example of the cross-vehicle beam 100 of FIG. 1 without the plate 114. Here, the cross section shows the cross-vehicle beam 100 from the side. For example, the open profile of the metal profile 102 can be characterized as a C-profile, which here opens toward the right in the illustration. The open profile has an opening 200. The rib 108 is visible, as is the metal plate 120.

Without sufficient reinforcement of the open profile, the cross-vehicle beam 100 could be subject to unwanted opening or breathing during use. Such opening or breathing is here schematically illustrated by arrows 202 and dashed lines 204. For example, the opening or breathing can involve vibrations in the top and bottom portions of the open profile. This likely degrades NVH performance and the overall quality of the vehicle.

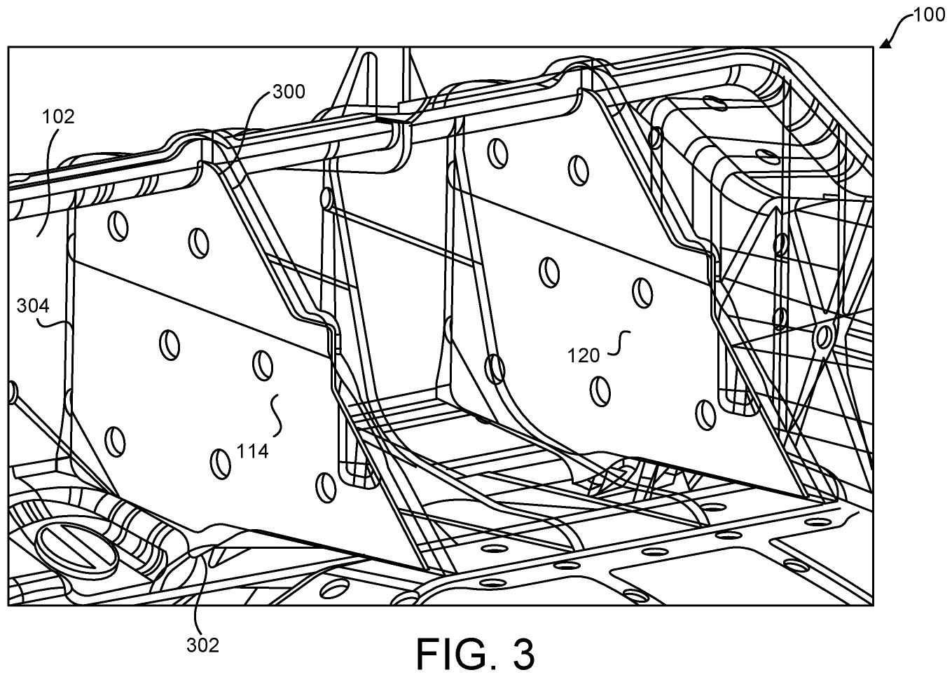

FIG. 3 shows an example of the cross-vehicle beam 100 of FIG. 1. The metal plates 114 and 120 are positioned in the open profile of the metal profile 102. Each of the plates 114 and 120 can include one or more features to facilitate a good fit against the metal profile 102. In some implementations, a mortise and tenon type of mating between the metal plate 114 and the metal profile 102 can be provided. Mating holes can be used. Here, tabs 300 and 302 on the metal plate 114 are visible. Each of the tabs 300-302 can be configured to extend into a respective slot in the metal profile 102.

In some implementations, overmolding is not performed and the cross-vehicle beam 100 may then not include the plastic material 104. The metal plates 114 and 120 can be welded to the metal profile 102. For example, the metal plate 114 can be attached to the metal profile 102 by at least one weld joint 304. In some implementations, the metal plates 114 and 120 are mounted to the metal profile 102 using respective bolt attachments.

A slide and lock attachment design can be implemented for mounting a section reinforcement component to the metal profile 102. The metal plates 114 and/or 120 can be temporarily held in place against the metal profile 102 until the permanent attachment process (e.g., welding, overmolding or bolting) is complete.

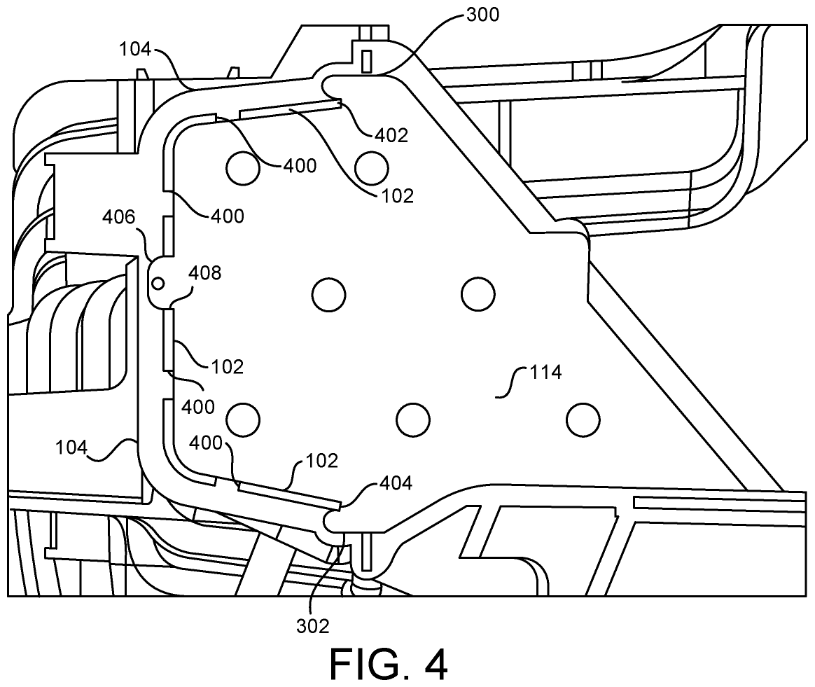

FIG. 4 shows an example cross section of the metal plate 114 of FIG. 3. This illustrates examples of mortise and tenon type of mating to position a reinforcement for an open profile. Holes 400 can extend through the metal profile 102. When overmolding is performed, the plastic material 104 can extend through the holes 400. The tab 300 of the metal plate 114 can extend into a slot 402 in the metal profile 102. The tab 302 of the metal plate 114 can extend into a slot 404 in the metal profile 102. A tab 406 of the metal plate 114 can extend into a slot 408 in the metal profile 102.

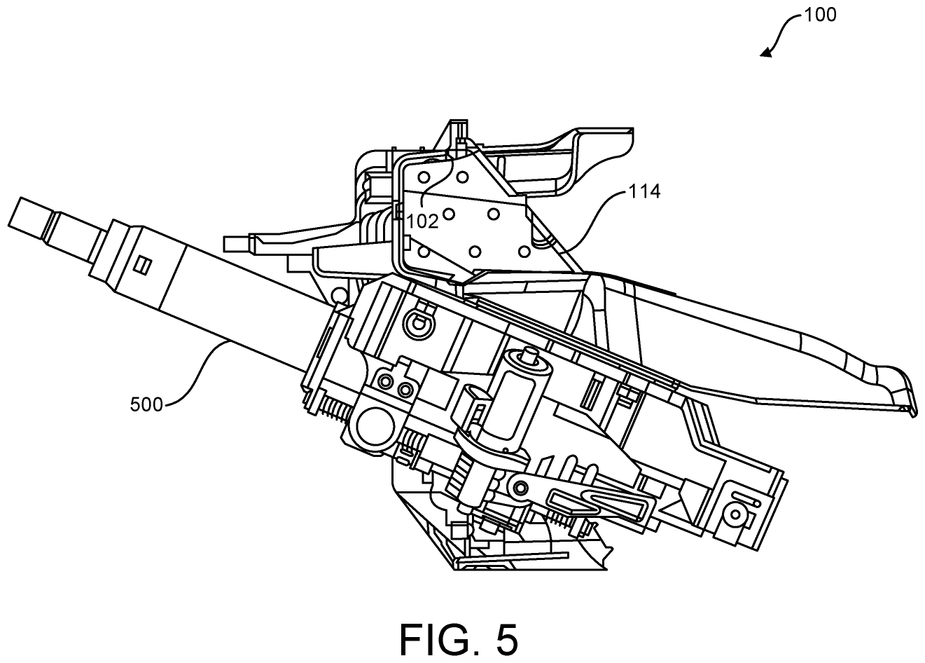

FIG. 5 shows an example of the cross-vehicle beam 100 of FIG. 1 with a steering column 500. The steering column 500 is suspended by the cross-vehicle beam 100 and can be used with one or more other examples described elsewhere herein. When the vehicle is driven, rotation of the steering column 500 up and down could tend to cause opening or breathing of the open profile of the metal profile 102. However, the cross-vehicle beam 100 reinforces the open profile using at least the metal plate 114. For example, the metal plate 114 can be positioned adjacent to the steering column 500 along the longitudinal axis of the cross-vehicle beam 100. As such, opening or breathing can be significantly reduced.

FIG. 6 shows an example of a vehicle 600. The vehicle 600 can be used with one or more other examples described elsewhere herein. The vehicle 600 is shown from above and has a vehicle body with a passenger compartment 602 that is here partially visible through the windows. The vehicle 600 can have an instrument panel 604 positioned at a front of the passenger compartment 602. In some implementations, the instrument panel 604 extends substantially from one side to the other of the vehicle 600 in a transverse direction. A structure 606 is schematically illustrated as extending transversely in the vehicle 600 and is currently obscured by the instrument panel 604. In some implementations, the structure 606 can include a open structural cross section that is reinforced using one or more metal plates. For example, the structure 606 can include the cross-vehicle beam 100 of FIG. 1.

The terms “substantially” and “about” used throughout this Specification are used to describe and account for small fluctuations, such as due to variations in processing. For example, they can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A vehicle comprising:
a vehicle body including a passenger compartment; and
a cross-vehicle beam extending in a transverse direction inside the passenger compartment, the cross-vehicle beam having an open profile, wherein an opening of the open profile faces forward in the vehicle, the cross-vehicle beam including a first metal plate, wherein a shape of a part of a periphery of the first metal plate corresponds to a shape of the open profile, and wherein the first metal plate is mounted in the open profile substantially perpendicular to a longitudinal axis of the cross-vehicle beam.

2. The vehicle of claim 1, further comprising an overmolding of a plastic material on the cross-vehicle beam, wherein the first metal plate is attached to the open profile by the overmolding.

3. The vehicle of claim 2, wherein the first metal plate includes a tab at the part of the periphery, wherein the open profile has a slot, and wherein the tab extends into the slot when the first metal plate is mounted in the open profile.

4. The vehicle of claim 2, wherein a first hole extends through the cross-vehicle beam, and wherein the plastic material extends through the first hole as a result of the overmolding.

5. The vehicle of claim 2, wherein a second hole extends through the first metal plate, and wherein the plastic material extends through the second hole as a result of the overmolding.

6. The vehicle of claim 1, wherein the first metal plate is attached to the open profile by at least one weld joint.

7. The vehicle of claim 6, wherein the first metal plate includes a tab at the part of the periphery, wherein the open profile has a slot, and wherein the tab extends into the slot when the first metal plate is mounted in the open profile.

8. The vehicle of claim 1, wherein the cross-vehicle beam further includes a second metal plate, wherein a shape of a part of a periphery of the second metal plate corresponds to the shape of the open profile, and wherein the second metal plate is mounted in the open profile substantially perpendicular to the longitudinal axis of the cross-vehicle beam.

9. The vehicle of claim 1, further comprising a steering column mounted to the cross-vehicle beam.

10. The vehicle of claim 9, wherein the first metal plate is positioned adjacent to the steering column along the cross-vehicle beam.

11. A vehicle structure comprising:
a metal beam having an open profile, the metal beam configured to be part of a vehicle body; and
a first metal plate, wherein a shape of a part of a periphery of the first metal plate corresponds to a shape of the open profile, and wherein the first metal plate is mounted in the open profile substantially perpendicular to a longitudinal axis of the metal beam.

12. The vehicle structure of claim 11, further comprising an overmolding of a plastic material on the metal beam, wherein the first metal plate is attached to the open profile by the overmolding.

13. The vehicle structure of claim 12, wherein the first metal plate includes a tab at the part of the periphery, wherein the open profile has a slot, and wherein the tab extends into the slot when the first metal plate is mounted in the open profile.

14. The vehicle structure of claim 12, wherein a first hole extends through the metal beam, and wherein the plastic material extends through the first hole as a result of the overmolding.

15. The vehicle structure of claim 12, wherein a second hole extends through the first metal plate, and wherein the plastic material extends through the second hole as a result of the overmolding.

16. The vehicle structure of claim 11, wherein the first metal plate is attached to the open profile by at least one weld joint.

17. The vehicle structure of claim 16, wherein the first metal plate includes a tab at the part of the periphery, wherein the open profile has a slot, and wherein the tab extends into the slot when the first metal plate is mounted in the open profile.

18. The vehicle structure of claim 11, further comprising a second metal plate, wherein a shape of a part of a periphery of the second metal plate corresponds to the shape of the open profile, and wherein the second metal plate is mounted in the open profile substantially perpendicular to the longitudinal axis of the metal beam.

19. The vehicle structure of claim 11, wherein the vehicle structure is a cross-vehicle beam.
